(19) United States
(12) Patent Application Publication
(10) Pub. No.: US 2025/0239393 A1
(43) Pub. Date: Jul. 24, 2025

(54) INDUCTOR AND METHOD FOR MANUFACTURING INDUCTOR

(71) Applicant: Murata Manufacturing Co., Ltd., Kyoto-fu (JP)

(72) Inventors: Yoshiyuki NOMURA, Nagaokakyo-shi (JP); Atsuyuki MATSUMURA, Nagaokakyo-shi (JP)

(73) Assignee: Murata Manufacturing Co., Ltd., Kyoto-fu (JP)

(21) Appl. No.: 18/923,281

(22) Filed: Oct. 22, 2024

(30) Foreign Application Priority Data
Jan. 23, 2024 (JP) 2024-008271

(51) Int. Cl. H01F 27/29; H01F 27/255; H01F 41/04

(52) U.S. Cl. CPC H01F 27/29; H01F 27/255; H01F 41/04

(57) ABSTRACT

An inductor includes: an element body that contains metal magnetic particles and a resin and encloses a coil conductor; and an outer electrode that is disposed on a surface of the element body and connected to the coil conductor, and includes a copper plating layer. The metal magnetic particles include particles containing iron (Fe). An intermediate layer containing phosphorus (P) and oxygen (O) or containing sulfur(S) and oxygen (O) is provided between the surface of the element body and the copper plating layer of the outer electrode.

### CROSS-REFERENCE TO RELATED APPLICATION

This application claims benefit of priority to Japanese Patent Application No. 2024-008271, filed Jan. 23, 2024, the entire content of which is incorporated herein by reference.

### BACKGROUND

### Technical Field

The present disclosure relates to an inductor and a method for manufacturing an inductor.

### Background Art

Japanese Unexamined Patent Application Publication No. 2023-72640 discloses an inductor which includes an element body containing metal magnetic particles and a resin, a coil conductor disposed in the element body, and an outer electrode including a copper (Cu) plating layer formed on the surface of the element body. The Cu plating layer is formed by, for example, electrolytic plating.

Fixing strength between an element body and an outer electrode can greatly affect the environmental resistance (for example, resistance to temperature, humidity, vibration, impact, and so forth) and long-term reliability of the corresponding inductor.

### SUMMARY

Accordingly, the present disclosure improves the fixing strength of an outer electrode on a surface of an element body in an inductor which includes the element body containing metal magnetic particles and a resin, a coil conductor disposed in the element body, and the outer electrode formed on the surface of the element body.

An aspect of the present disclosure is an inductor including an element body that contains metal magnetic particles and a resin and encloses a coil conductor; and an outer electrode that is disposed on a surface of the element body and connected to the coil conductor, and includes a copper plating layer. The metal magnetic particles include particles containing iron (Fe). An intermediate layer containing phosphorus (P) and oxygen (O) or containing sulfur(S) and oxygen (O) is provided between the surface of the element body and the copper plating layer of the outer electrode.

Another aspect of the present disclosure is a method for manufacturing an inductor, the method including a step for forming a coil having a pair of extended portions; a step for embedding the coil in an element body, which includes metal magnetic particles containing iron (Fe) and a resin, such that the extended portions of the coil are exposed from a surface of the element body; and a step for at least partially forming an intermediate layer, which contains phosphorus (P) and oxygen (O) or containing sulfur(S) and oxygen (O), in an outer electrode forming region, which includes the extended portions exposed from the element body, on the surface of the element body. The method further includes a step for forming an outer electrode including a copper (Cu) plating layer in the outer electrode forming region at least partially formed with the intermediate layer.

According to the present disclosure, in an inductor which includes an element body containing metal magnetic particles and a resin, a coil conductor disposed in the element body, and an outer electrode formed on a surface of the element body, the fixing strength of the outer electrode on the surface of the element body can be improved.

### BRIEF DESCRIPTION OF THE DRAWINGS

FIG. 1 is a perspective view of an inductor according to an embodiment of the present disclosure, as viewed from the upper surface side;

FIG. 2 is a perspective view of the inductor as viewed from the bottom surface side;

FIG. 3 is a perspective view showing an internal configuration of the inductor;

FIG. 4 is a plan perspective view of the inductor shown in FIG. 3, as viewed from the upper surface side;

FIG. 5 is a sectional view of the inductor taken along a V-V line in FIG. 4;

FIG. 6 is a partial detailed view of a portion P in the cross section shown in FIG. 5;

FIG. 7 is a diagram showing a process for manufacturing an inductor;

FIG. 8 is an example of an SEM image of a cross section of an inductor used for evaluation of in-film elements of an intermediate layer; and

FIGS. 9A to 9E are examples of EDX analysis images of the cross section of the inductor used for evaluation of in-film elements of the intermediate layer.

### DETAILED DESCRIPTION

When a Cu plating layer constituting an outer electrode is formed by electroplating on a surface of an element body containing metal magnetic particles and a resin, the fixing strength of the Cu plating layer on the surface of the element body is affected by the state of the surface of the element body at the start of an electrolytic plating process.

The inventors have conducted intensive studies on fixing strength of outer electrodes on surfaces of element bodies and have confirmed that a Cu substitution plating layer formed on a surface of an element body when the element body is immersed in a Cu electrolytic plating solution is one factor of reduction in the fixing strength of a Cu plating layer, which is formed by a subsequent electrolytic plating process, to the surface of the element body.

Such a Cu substitution plating layer can be formed in a short period of time (for example, several seconds) after an element body is immersed in a Cu electrolytic plating solution, and prevention of the formation of the Cu substitution plating layer is difficult only by devising a plating process.

The present disclosure has been made based on the above-mentioned findings, and from the aspect of an inductor configuration, the present disclosure suppresses reduction in the fixing strength of a Cu electrolytic plating layer, which is caused by the formation of a Cu substitution plating layer, so as to improve the connection strength of an outer electrode.

Hereinafter, embodiments of the present disclosure will be described with reference to the accompanying drawings.

### 1. CONFIGURATION OF INDUCTOR

First, the configuration of an inductor 1 according to the present embodiment will be described.

### 1.1 Overall Configuration of Inductor

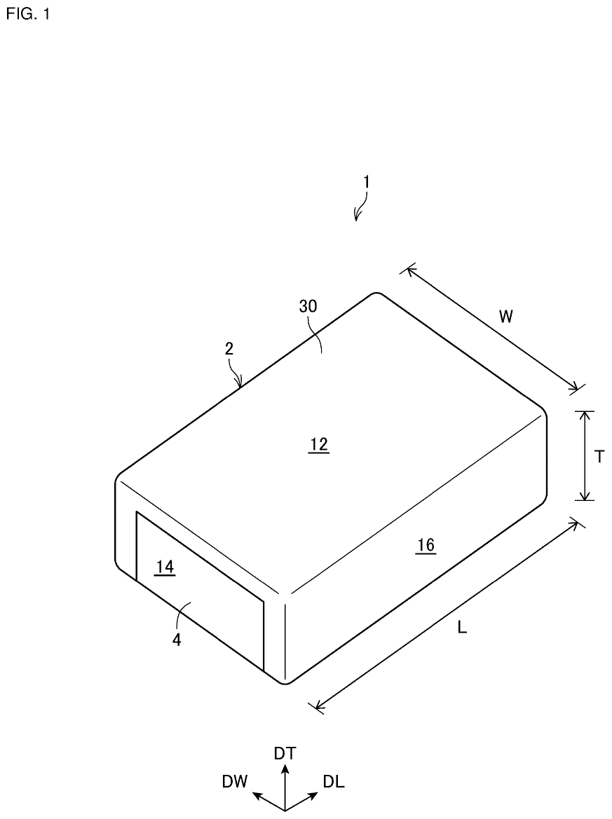

FIGS. 1, 2, and 3 are diagrams showing the overall configuration of the inductor 1.

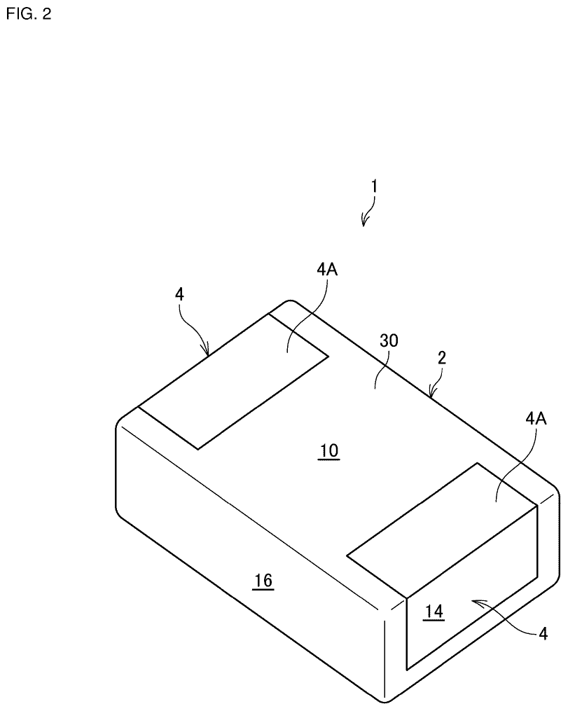

FIG. 1 is a perspective view of the inductor 1 as viewed from an upper surface 12 side, and FIG. 2 is a perspective view of the inductor 1 as viewed from a bottom surface 10 side.

The inductor 1 of the present embodiment is configured as a surface-mounted type electronic component and includes an element body 2 having a substantially rectangular parallelepiped shape which is one aspect of a substantially hexahedral shape and a pair of outer electrodes 4 provided on the surface of the element body 2.

Hereinafter, in the element body 2, a first main surface facing a mounting substrate, which is not shown, at the time of mounting is defined as the bottom surface 10, a second main surface opposed to the bottom surface 10 is referred to as the upper surface 12, a pair of third main surfaces orthogonal to the bottom surface 10 are referred to as end surfaces 14, and a pair of fourth main surfaces orthogonal to the bottom surface 10 and the pair of end surfaces 14 are referred to as side surfaces 16.

As shown in FIG. 1, the distance from the bottom surface 10 to the upper surface 12 is defined as the thickness T of the element body 2, the distance between the pair of side surfaces 16 is defined as the width W of the element body 2, and the distance between the pair of end surfaces 14 is defined as the length L of the element body 2. The direction of the thickness T is defined as a thickness direction DT, the direction of the width W is defined as a width direction DW, and the direction of the length L is defined as a length direction DL.

The inductor has dimensions of, for example, the length L of 2.0 mm, the width W of 1.2 mm, and the thickness T of 0.9 mm.

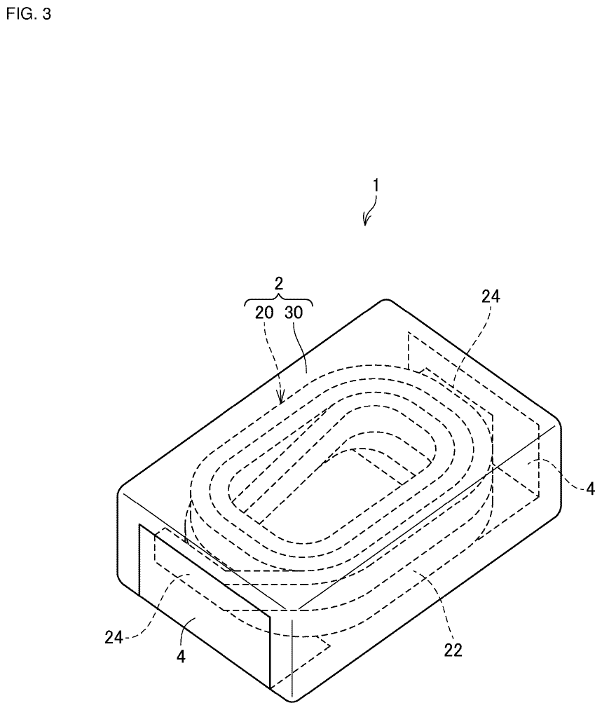

FIG. 3 is a perspective view showing the internal configuration of the inductor.

The element body 2 includes a coil conductor 20 and a core 30 which has a substantially hexahedral shape and in which the coil conductor 20 is embedded, and the element body 2 is configured as a molded inductor in which the coil conductor 20 is sealed in the core 30.

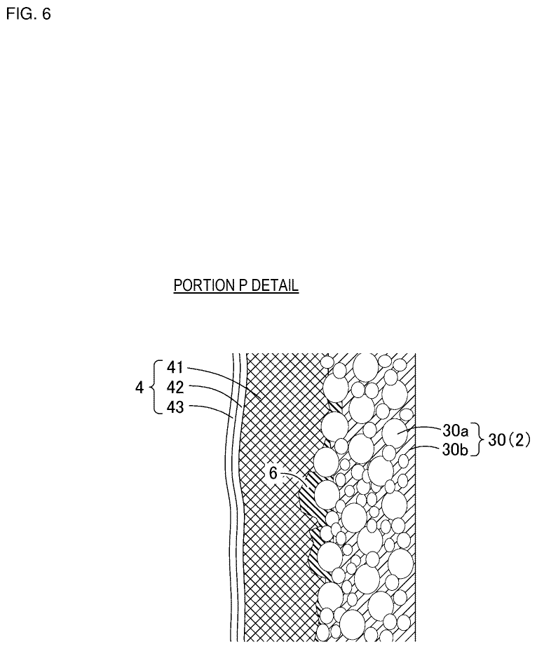

The core 30 is a molded body that is compression-molded into a substantially hexahedral shape by pressurizing and heating a mixed powder, in which metal magnetic particles 30a and resin 30b (see FIG. 6) are mixed, in a state in which the coil conductor 20 is enclosed. The mixed powder may contain a solvent and/or a curing agent. The mixed powder may further contain an additive such as a lubricant.

The metal magnetic particles 30a of the present embodiment include particles of two types of particle size, namely first magnetic particles that are large particles having a relatively large average particle size, and second magnetic particles that are small particles having a relatively small average particle size. Accordingly, the second magnetic particles, which are small particles, enter between the first magnetic particles, which are large particles, with the resin during the compression-molding, thereby being able to increase the filling rate of the metal magnetic particles 30a in the core 30 and also increase magnetic permeability.

In the present embodiment, the D50 particle sizes (median diameters) of metal particles of the first magnetic particles and the second magnetic particles are 28 μm and 4.0 μm, respectively. The D50 particle size of the first magnetic particles is preferably from 10 μm to 50 μm inclusive, and the D50 particle size of the second magnetic particles is preferably from 1 μm to 5 μm inclusive. The magnetic particles may include particles having an average particle size which is different from those of the first magnetic particles and the second magnetic particles, and thus the magnetic particles may include particles having three or more kinds of particle sizes.

Each of the first magnetic particles and the second magnetic particles is a particle including a metal particle and an insulating film covering the surface of the metal particle. The metal particle is covered with the insulating film, and thus the insulation resistance and the withstand voltage are increased.

For example, Fe-based metal magnetic particles such as pure iron (Fe) or an Fe alloy are used as the metal particles of the first magnetic particles and second magnetic particles. As an example of the Fe alloy, one or more alloys selected from the group consisting of an alloy containing Fe and Ni, an alloy containing Fe and Co, an alloy containing Fe and Si, an alloy containing Fe, Si, and Cr, an alloy containing Fe, Si, and Al, an alloy containing Fe, Si, B, and Cr, and an alloy containing Fe, P, Cr, Si, B, Nb, and C can be used.

The composition of the metal particles of the first magnetic particles and the composition of the metal particles of the second magnetic particles may be the same as each other or different from each other.

The insulating film formed on the surfaces of the metal particles of the first magnetic particles and the second magnetic particles may be, for example, one or more insulating films selected from the group consisting of an inorganic glass film, an organic-inorganic hybrid film, and an inorganic insulating film formed by a sol-gel reaction of metal alkoxide.

In the present embodiment, Fe—Si—Cr amorphous alloy powder is used as the metal particles of the first magnetic particles, and Fe—Si—Cr amorphous alloy powder is used as the metal particles of the second magnetic particles.

In the above-mentioned mixed powder, the resin material to be used may be at least one selected from the group consisting of an epoxy resin, a phenol resin, a polyester resin, a polyimide resin, a polyolefin resin, and a silicone resin. In particular, when an epoxy resin is used as the resin, a magnetic molded body having high electrical insulation properties and/or high mechanical strength can be obtained. In addition to the above, as the resin material, a thermoplastic resin such as polyamide imide, polyphenylene sulfide, and/or a liquid crystal polymer may be used. The curing reaction is preferably generated by heat. That is, the resin is preferably a thermosetting resin. An example is a thermosetting epoxy resin. When such a resin is used, a curing reaction can be generated by a simple method.

A solvent for obtaining a slurry by mixing the metal magnetic particles 30a and the resin 30b can be added to the mixed powder. The solvent is preferably an organic solvent. For example, the solvent may include any of aromatic hydrocarbons such as toluene and xylene; ketones such as acetone, methyl ethyl ketone, and methyl isobutyl ketone; alcohols such as methanol, ethanol, and isopropyl alcohol; and glycol ethers such as propylene glycol monomethyl ether and propylene glycol monomethyl ether acetate.

A curing agent for curing resin may be added to the mixed powder. As an example, the curing agent may include any of an imidazole-based curing agent, an amine-based curing agent, or a guanidine-based curing agent (for example, dicyandiamide).

A lubricant may be added to the mixed powder in order to improve the lubricity of the first magnetic particles and the second magnetic particles to improve the filling rate. The lubricant may be added for the purpose of facilitating release from a mold during molding. The lubricant may include, for example, any of nanosilica, barium sulfate, and a stearic acid compound (lithium stearate, magnesium stearate, zinc stearate, potassium stearate, or the like).

In terms of the weight ratio of raw materials contained in the mixed powder, the first magnetic particles and the second magnetic particles may be from 94% by weight to 98% by weight inclusive on the basis of the total weight, the resin and the curing agent may be from 1% by weight to 5% by weight inclusive on the basis of the total weight, and the lubricant and the solvent may be the remainder. The ratio of first magnetic raw material particles and second magnetic raw material particles is preferably the weight of the first magnetic raw material particles: the weight of the second magnetic raw material particles=10:90 or more and 50:50 or less. The ratio of the resin and the curing agent is preferably the weight of the resin: the weight of the curing agent=95:5 or more and 98:2 or less.

As shown in FIG. 3, the coil conductor 20 includes a winding portion 22 formed by winding a conductive wire, and a pair of extended portions 24 that are extended from the winding portion 22 and at least partially exposed from the element body 2.

The coil conductor 20 is composed of a conductive wire and a coating layer formed on a surface of the conductive wire. The conductive wire is a strip-shaped conductive wire made of copper and having a rectangular cross section (so-called rectangular conductive wire).

The coil conductor 20 is not necessarily wound, and may have a linear shape, a meander shape, or the like.

The winding portion 22 of the coil conductor 20 is formed by winding a strip-shaped conductive wire (hereinafter, also simply referred to as a conductive wire) in a spiral shape such that both ends of the conductive wire are extended to the outer periphery and are connected to each other at the inner periphery. Inside the element body 2, the coil conductor 20 is embedded in the core 30 in a posture in which the central axis of the winding portion 22 is along the thickness direction DT of the element body 2. The respective extended portions 24 are extended from the winding portion 22 to the pair of end surfaces 14, one main surfaces thereof are exposed from the element body 2, and the other main surfaces thereof are embedded in the element body 2. The one main surfaces of the extended portions 24 exposed from the element body 2 are electrically connected to the respective outer electrodes 4.

The pair of outer electrodes 4 is so-called L-shaped electrodes composed of L-shaped members which extend from the respective end surfaces 14 of the element body 2 to the bottom surface 10. Each of the outer electrodes 4 is connected with the extended portion 24 of the coil conductor 20 on the end surface 14, and a portion 4A (FIG. 2) extending on the bottom surface 10 is electrically connected with wiring of the circuit substrate by an appropriate mounting means such as solder.

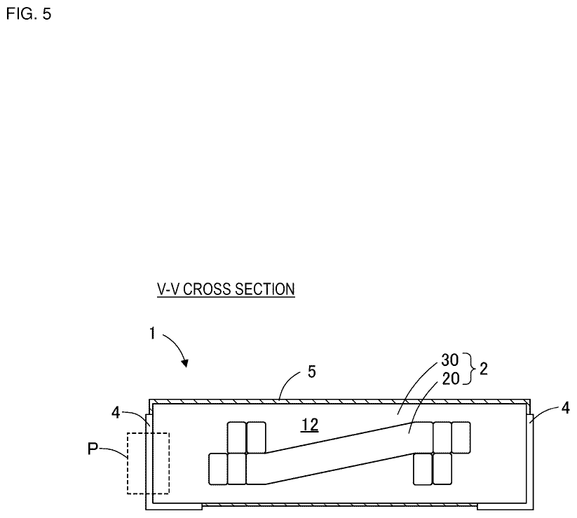

An element body protection layer 5 (see FIG. 5, not shown in FIGS. 1 to 4), which is an insulating film, is formed on the surface of the element body 2 except for the range of the outer electrodes 4. The element body protection layer 5 is, for example, an epoxy resin, a phenoxy resin, or a novolac resin, and a material containing metal oxide fine particles can be used as a filler. In the present embodiment, the element body protection layer 5 contains a filler of silicon dioxide, which is metal oxide fine particles, and an epoxy resin. The element body protection layer 5 may be a resin such as urethane, acrylic, polyimide, polyimide amide, and polyamide, or glass, or an oxide film, in addition to the above-described materials.

Inductors having such a configuration can improve DC superposition characteristics by using a soft magnetic material for magnetic particles, and are accordingly used as electronic components of electric circuits through which a large current flows, or choke coils of DC-DC converter circuits and power supply circuits, and are used for electronic components of electronic devices such as a personal computer, a DVD player, a digital camera, a TV, a mobile phone, a smartphone, car electronics, and medical/industrial machines. However, the use of the inductors is not limited thereto, and the inductors can also be used in, for example, tuning circuits, filter circuits, rectifying and smoothing circuits, and the like.

### 1.2 Configuration of Boundary Portion Between Surface of Element Body and Outer Electrode

Next, the configuration of a boundary portion between the surface of the element body 2 and the outer electrode 4 will be further described.

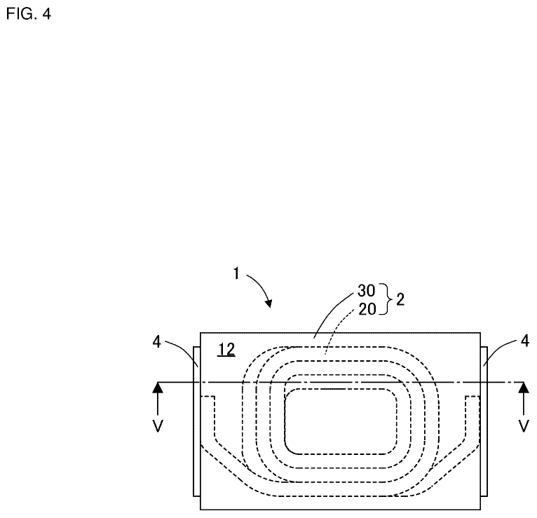

FIG. 4 is a plan perspective view of the inductor 1 shown in FIGS. 1 and 3, as viewed from the upper surface 12 side. FIG. 5 is a sectional view of the inductor 1 taken along the V-V line in FIG. 4, and FIG. 6 is a partial detailed view of a portion P in the cross section shown in FIG. 5.

Referring to FIG. 6, the outer electrode 4 includes a copper (Cu) plating layer 41 as the lowermost layer closest to the surface of the element body. The Cu plating layer 41 is connected to the extended portion 24 (not shown in FIG. 6) of the coil conductor 20 exposed on the surface of the element body 2. In the present embodiment, the Cu plating layer 41 is formed by electrolytic plating.

The outer electrode 4 may further include a nickel (Ni) plating layer 42 formed on the Cu plating layer 41 and a tin (Sn) plating layer 43 formed on the Ni plating layer 42. The corrosion resistance and solder wettability of the outer electrode 4 are improved by the Ni plating layer 42 and the Sn plating layer 43. The Ni plating layer 42 and the Sn plating layer 43 may also be formed by electrolytic plating.

In the present embodiment, in particular, an intermediate layer 6 is disposed between the surface of the element body 2 and the Cu plating layer 41 in order to prevent Cu substitution plating from being formed on the surface of the metal magnetic particles, which contain Fe and are exposed from the surface of the element body 2, when the element body 2 is immersed in an electrolytic plating solution in forming the Cu plating layer 41.

As described later, the intermediate layer 6 is formed to contain phosphorus (P) and oxygen (O) or contain sulfur(S) and oxygen (O), thereby suppressing the formation of the Cu substitution plating layer and being able to improve the fixing force between the Cu plating layer 41 and the surface of the element body 2. As described later, the intermediate layer 6 containing phosphorus (P) and oxygen (O) can be formed by using pyrophosphoric acid (chemical formula: H₄P₂O₇) which can be generally used for preparing a Cu electrolytic plating solution, and the intermediate layer 6 containing sulfur(S) and oxygen (O) can be formed by using ammonium sulfate (chemical formula: (NH₄)₂SO₄) which can be generally used for preparing a Ni electrolytic plating solution. That is, the intermediate layer 6 containing phosphorus (P) and oxygen (O) or containing sulfur(S) and oxygen (O) has an advantage that the intermediate layer 6 can be easily formed by using the same chemical agent as that used for forming the outer electrode 4.

The intermediate layer 6 may further contain potassium (K). The intermediate layer 6 containing phosphorus (P), oxygen (O), and potassium (K) can be formed by using potassium pyrophosphate (chemical formula: K₄O₇P₂) which can be generally used in a Cu electrolytic plating solution, and the intermediate layer 6 containing sulfur(S), oxygen (O), and potassium (K) can be formed by using potassium sulfate (chemical formula: K₂SO₄) which can be generally used in a Ni electrolytic plating solution. In particular, since potassium pyrophosphate that can be used in a Cu electrolytic plating solution is used for the intermediate layer 6 containing phosphorus (P), oxygen (O), and potassium (K), the process can be simplified by omitting cleaning of the element body 2 between the step for forming the intermediate layer 6 and the step for forming the Cu plating layer 41.

From the viewpoint of preventing the formation of a Cu substitution plating layer on the surfaces of the metal magnetic particles 30a exposed on the surface of the element body 2, the intermediate layer 6 may be disposed at least between the metal magnetic particles 30a and the Cu plating layer 41, and is not necessarily formed on the resin 30b constituting the core 30 of the element body 2. By disposing the intermediate layer 6 between the metal magnetic particles 30a and the Cu plating layer 41, it is possible to more effectively prevent reduction in the fixing strength between the Cu plating layer 41 and the element body 2 caused by an Fe—Cu substitution reaction in the step for forming the Cu plating layer 41, and to improve the connection strength between the outer electrode 4 and the element body 2.

The intermediate layer 6 is not disposed between the element body 2 and the element body protection layer 5 covering the surface of the element body 2. This can prevent an adverse effect on the adhesion strength between the element body 2 and the element body protection layer 5, which may occur when the intermediate layer 6 is present between the surface of the element body 2 and the element body protection layer 5.

The intermediate layer 6 may have a thickness that is not uniform along the surface of the element body 2. This is because even if the intermediate layer 6 is not uniform in thicknesses, the intermediate layer 6 can prevent the formation of a Cu substitution plating layer on the surfaces of the metal magnetic particles 30a as long as the intermediate layer 6 is present on the surfaces of the metal magnetic particles 30a. In addition, since the intermediate layer 6 does not need to be formed to have a uniform thickness along the surface of the element body 2, the intermediate layer 6 can be easily formed.

Further, the intermediate layer 6 does not need to be continuously formed along the surface of the element body 2, and may be discontinuous along the surface of the element body 2 as shown in FIG. 6. Even if the intermediate layer 6 is discontinuously formed, the intermediate layer 6 can prevent the formation of a Cu substitution plating layer in the region covering the surfaces of the metal magnetic particles 30a, and accordingly can prevent reduction in the overall fixing force of the Cu plating layer 41 with respect to the surface of the element body 2. Further, the configuration in which the intermediate layer 6 does not need to be continuously formed along the surface of the element body 2 can facilitate the formation of the intermediate layer 6.

The average thickness of the intermediate layer 6 in the region where the Cu plating layer 41 is formed is preferably from 0.01 μm to 50 μm inclusive, and more preferably from 0.5 μm to 20 μm inclusive. This is because, if the intermediate layer 6 is too thin, the effect of preventing the formation of a Cu substitution plating layer is reduced, and if the intermediate layer 6 is too thick, it may be necessary to sacrifice the electrical characteristics by reducing the outer dimensions of the element body 2 in order to keep the outer dimensions of the inductor 1 within an allowable range.

The surface roughness, which is represented by the arithmetic average roughness Ra, in the region of the surface of the element body 2 where the Cu plating layer 41 is formed is preferably from 1.0 μm to 10 μm inclusive. Accordingly, the anchoring effect obtained by the uneven surface of the element body 2 further increases the fixing force between the intermediate layer 6 and the surface of the element body 2 or the fixing force of the intermediate layer 6 and the Cu plating layer 41 with respect to the surface of the element body 2, being able to further improve the fixing strength between the outer electrode 4 and the surface of the element body 2.

The resistivity (for example, volume resistivity) of the intermediate layer 6 may be in any numerical range of a conductor or an insulator, and is not necessarily have to be constant along the surface of the element body 2.

### 2. PROCESS FOR MANUFACTURING INDUCTOR

The inductor 1 can be manufactured as follows.

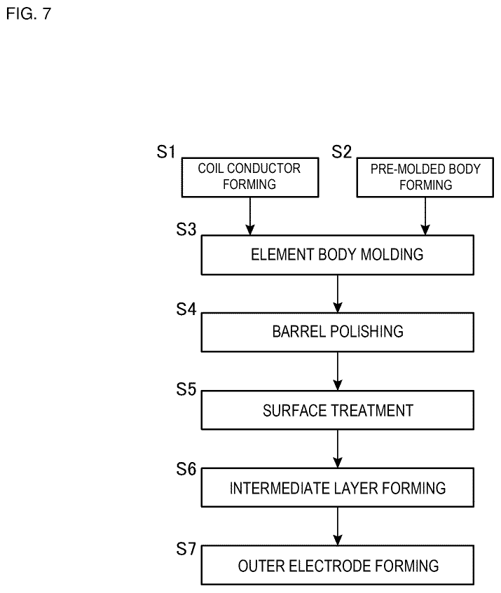

FIG. 7 is a diagram showing a process for manufacturing the inductor 1.

The process for manufacturing the inductor 1 may include a coil conductor forming step (S1), a pre-molded body forming step (S2), an element body molding step (S3), a barrel polishing step (S4), a surface treatment step (S5), an intermediate layer forming step (S6), and an outer electrode forming step (S7).

The coil conductor forming step (S1) is a step for forming the coil conductor 20 from a conductive wire. In this step, the coil conductor 20 is formed into a shape, which has the winding portion 22 and the pair of extended portions 24 described above, by winding a conductive wire in a winding manner called “alpha winding”. The alpha winding refers to a state in which a conducting wire functioning as a conductor is wound in two stages in a spiral shape such that the extended portions 24 at the winding start and the winding end are positioned on the outer periphery. The number of turns of the coil conductor 20 is not particularly limited.

The pre-molded body forming step (S2) is a step for forming a pre-molded body called a tablet.

The pre-molded body is obtained in a manner such that the above-mentioned mixed powder, which is the material of the element body 2, is pressurized to be molded into a solid shape that is easy to handle. In the present embodiment, two types of tablets are formed, namely, a first tablet having an appropriate shape (for example, an E shape) with a groove into which the coil conductor 20 enters, and a second tablet having an appropriate shape (for example, an I shape or a plate shape) that covers the groove of the first tablet.

In the element body molding step (S3), the first tablet, the coil conductor, and the second tablet are set in a mold, and are pressurized in the direction, in which the first tablet and the second tablet overlap each other, while being heated, and are cured, thereby integrating the first tablet, the coil conductor, and the second tablet. As a result, the element body 2 in which the coil conductor 20 is enclosed in the core 30 is molded.

In the barrel polishing step (S4), a plurality of element bodies 2 are filled in a drum, and the drum is rotated so that an excessively strong impact is not applied. Further, a coating liquid for forming the element body protection layer 5 is sprayed by a spray. Thus, the corner portions of the element body 2 are rounded, and the coating liquid is applied to the element body 2. In the present embodiment, the coating liquid contains a filler of silicon dioxide which is metal oxide fine particles and an epoxy resin which is an organic resin.

Next, the element body 2 coated with the coating liquid is taken out from the drum and subjected to heat treatment, whereby the element body protection layer 5 is formed on the surface of the element body 2.

The formation of the element body protection layer 5 is not limited to the above, and may be performed by various methods such as spraying a coating liquid onto the element body 2, dipping the element body 2 in a coating liquid, supplying a coating liquid to the surface of the element body 2 via a dispenser, and/or printing a coating material on the surface of the element body 2 by various printing methods, by adding a step separate from the barrel polishing step (S4).

The surface treatment step (S5) is a step for irradiating the surface of the core 30 at pre-electrode portions with laser light so as to modify the surfaces of the pre-electrode portions. Here, the pre-electrode portion refers to a range on the surface of the core 30 where the outer electrode 4 is to be formed, and includes a portion where the extended portion 24 is exposed. Specifically, by radiating laser light, the element body protection layer 5 on the surface of the core 30 and a coating layer of the extended portion 24 of the coil conductor 20 are removed in the range of the pre-electrode portions, the resin 30b on the surface of the core 30 is removed, and insulating films on the surfaces of the metal magnetic particles 30a exposed from the core 30 are removed. As a result, the exposed area of the metal of the metal magnetic particles 30a per unit surface area of the core 30 is larger in the pre-electrode portions of the surface of the core 30 than in other surface portions of the core 30.

The wavelength of the laser light is, for example, from 180 nm to 3000 nm inclusive, and more preferably from 532 nm to 1064 nm inclusive. The irradiation energy of the laser light is preferably from 1 W/mm² to 30 W/mm² inclusive, and more preferably from 5 W/mm² to 12 W/mm² inclusive.

In the intermediate layer forming step (S6), the element body 2 is immersed in a treatment liquid to form the intermediate layer 6 at the pre-electrode portions of the core 30 of the element body 2. For example, when a layer containing phosphorus (P) and oxygen (O) is formed as the intermediate layer 6, a solution containing polyphosphoric acid can be used as the treatment liquid. In addition, when a layer containing sulfur(S) and oxygen (O) is formed as the intermediate layer 6, for example, a solution containing sulfate ions can be used as the treatment liquid.

More specifically, as the treatment liquid containing polyphosphoric acid, for example, an aqueous solution of pyrophosphoric acid or potassium pyrophosphate can be used. Further, as the treatment liquid containing sulfate ions, for example, an aqueous solution of ammonium sulfate or potassium sulfate can be used.

As described above, when the aqueous solution containing potassium pyrophosphate or potassium sulfate is used, a layer further containing potassium (K) can be formed as the intermediate layer 6.

The thickness of the intermediate layer 6 can be controlled by adjusting the concentration and temperature of the treatment liquid and/or the immersion time of the element body 2 in the treatment liquid.

In the outer electrode forming step (S7), the outer electrodes 4 are formed at the pre-electrode portions on the core 30 on which the intermediate layer 6 is formed. Specifically, the Cu plating layer 41 is first formed by electrolytic plating on the pre-electrode portion on the core 30 on which the intermediate layer 6 is formed. Subsequently, the Ni plating layer 42 and the Sn plating layer 43 may be formed on the Cu plating layer 41 by electrolytic plating.

In the method for forming the Cu plating layer 41, for example, copper sulfate plating, copper pyrophosphate plating, or copper cyanide plating can be used as electrolytic copper plating.

When the Ni plating layer 42 and the Sn plating layer 43 are formed, an additive such as a gloss agent may be added to the plating solution.

### 3. EXAMPLE

Examples of the inductor 1 will now be described.

Examples and Comparative Example shown in Table 1 were produced, and the fixing strength of the outer electrode 4 with respect to the element body 2 was evaluated. Examples 1 to 6 were produced under the same production conditions by the manufacturing process shown in FIG. 7 described above, but production conditions for the intermediate layer 6 in the intermediate layer forming step (S6) were different from each other. Comparative Example was a sample without the intermediate layer 6, and was produced under the same production conditions as those of Examples 1 to 6 except that the intermediate layer forming step was not performed. The production number was 30 for each of Examples 1 to 6 and Comparative Example.

TABLE 1

| | Production Conditions for Intermediate Layer | | | |
|---|---|---|---|---|
| | | Treatment | | |
| | | liquid | Immersion | |
| | Type of treatment liquid | temperature | time | |
| Example 1 | Pyrophosphoric acid | 60° C. | 5 | minutes |
| | aqueous solution | | | |
| | (concentration: 500 g/L) | | | |
| Example 2 | Ammonium sulfate | 60° C. | 5 | minutes |
| | aqueous solution | | | |
| | (concentration: 500 g/L) | | | |
| Example 3 | Potassium pyrophosphate | 60° C. | 5 | minutes |
| | aqueous solution | | | |
| | (concentration: 500 g/L) | | | |
| Example 4 | Potassium sulfate | 60° C. | 5 | minutes |
| | aqueous solution | | | |
| | (concentration: 500 g/L) | | | |
| Example 5 | Potassium pyrophosphate | 60° C. | 1 | minute |
| | aqueous solution | | | |
| | (concentration: 500 g/L) | | | |
| Example 6 | Potassium pyrophosphate | 60° C. | 30 | minutes |
| | aqueous solution | | | |
| | (concentration: 500 g/L) | | | |

| | |
|---|---|
| Comparative | No intermediate layer |
| Example | |

### 3.1 Production of Examples and Comparative Example

### Production of Element Body

In Examples 1 to 6 and Comparative Example, the composition of the mixed powder in the pre-molded body forming step (S2) was as follows.

Metal magnetic particles 30a:

First magnetic particles: D50 particle size 28 μm

Fe-6.7Si-2.5Cr amorphous alloy

(Fe:Si:Cr=90.8:6.7:2.5 (weight ratio))
Second magnetic particles: D50 particle size 4.0 μm
Fe-6.7Si-2.5Cr amorphous alloy
(Fe:Si:Cr=90.8:6.7:2.5 (weight ratio))
Resin 30b: thermosetting epoxy resin
Curing agent: imidazole
Lubricant: nanosilica (diameter 50 nmφ), particulate shape

The weight ratio of the first magnetic particles and the second magnetic particles in the mixed powder is 96.0% by weight based on the total mixed powder, the weight ratio of the resin and the curing agent is 3.6% by weight based on the total mixed powder, and the lubricant is 0.4% by weight based on the total mixed powder.

The pressure molding conditions of the element body 2 in the element body molding step (S3) are a temperature of 180° C., a pressure of 20 Mpa, and a pressurizing time of 600 seconds. In the core 30 of the element body 2 after molding, the weight ratio of the first magnetic particles: the weight ratio of the second magnetic particles=25:75, and the weight ratio of the resin: the weight ratio of the curing agent=97.4:2.6.

After the element body protection layer 5 was formed on the surface of the element body 2 in the barrel polishing step (S4), the pre-electrode portions including the exposed portions of the extended portion 24 of the coil conductor 20 on the surface of the element body 2 were irradiated with laser light in the surface treatment step (S5). The irradiation energy of the laser light is 12 W/mm².

### Formation of Intermediate Layer

In Examples 1 to 6, the intermediate layer 6 was formed by the intermediate layer forming step (S6).

The type of the treatment liquid used for forming the intermediate layer 6, the temperature of the treatment liquid, and the immersion time of the element body 2 in the treatment liquid in each of Examples 1 to 6 are as shown in Table 1.

### Formation of Outer Electrode

In Examples 1 to 6 and Comparative Example, the outer electrodes 4 were formed by the above-described outer electrode forming step (S7). The element body 2 was first put into a Cu plating bath (copper pyrophosphate plating solution) so as to form the Cu plating layer 41 by electrolytic plating. The average thickness of the Cu plating layer 41 along the surface of the element body 2 was 30 μm. Thereafter, the element body 2 was taken out from the Cu plating bath, washed with water, and then put into a Ni plating bath (Watts bath) so as to form the Ni plating layer 42 by electrolytic plating. The average thickness of the Ni plating layer 42 along the surface of the element body 2 was 5 μm. After that, the element body 2 was taken out from the Ni plating bath, washed with water, and then further put into a Sn plating bath (neutral bath) so as to form a semi-glossy Sn plating layer 43 by electrolytic plating. The average thickness of the Sn plating layer 43 along the surface of the element body 2 was 5 μm.

### 3.2 Evaluation

The average film thickness of the formed intermediate layer 6 was measured and in-film elements of the intermediate layer 6 was analyzed for produced Examples 1 to 6. A fixing test of the outer electrode 4 was performed on Examples 1 to 6 and Comparative Example.

### 3.2.1 Evaluation Method

The evaluation was performed by the following method.

### Measurement of Average Film Thickness and Analysis of In-Film Elements

First, for Examples 1 to 6, the element body 2 was polished in the DW direction (see FIG. 1) so as to obtain a cross section (hereinafter, referred to as an LT cross section) including the DT direction and the DL direction along the center line in the DW direction. Then, the thickness of the intermediate layer 6 was measured at arbitrary five points in the range where the intermediate layer 6 was formed in the obtained LT cross section, and the average value of the measured values was defined as the average film thickness of the intermediate layer 6.

Thereafter, in the LT cross section, SEM-EDX analysis was performed on a region including the boundary portion between the outer electrode 4 and the element body 2 to analyze the in-film elements of the intermediate layer 6.

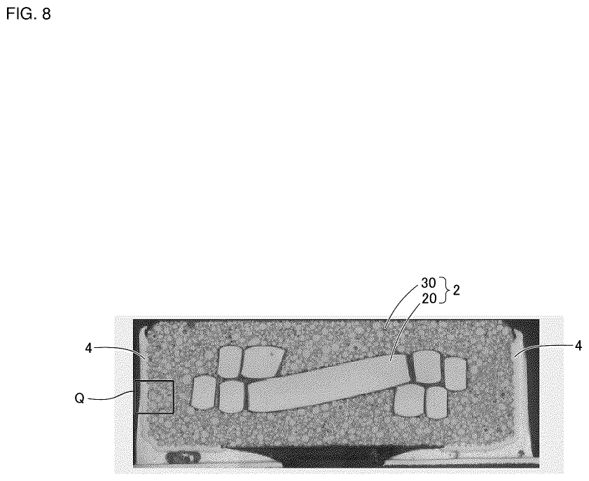

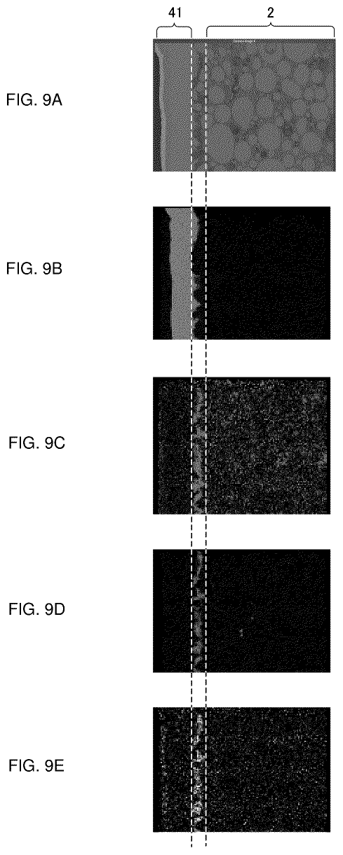

FIG. 8 is an example of an SEM (electron microscope) image of the LT cross section of the inductor 1 used for the evaluation of the in-film elements of the intermediate layer 6 in Example 3. The image of FIG. 8 shows the element body 2 including the coil conductor 20 and the core 30, and the outer electrodes 4 formed on the respective left and right end surfaces 14 of the element body 2. FIGS. 9A to 9E are examples of SEM (electron microscope) images and EDX analysis images of a region including the boundary portion between the outer electrode 4 and the element body 2 in the LT cross section of the element body 2, which were used for the evaluation of the in-film elements. Specifically, FIGS. 9A to 9E show SEM enlarged images and EDX images of a Q portion indicated by a dotted rectangle in the SEM image of FIG. 8.

FIG. 9A is an SEM image of the Q portion. Further, FIG. 9B is a characteristic X-ray image showing the presence of the element copper (Cu), which was observed in the EDX analysis of the Q portion. In this image, bright spots showing the presence of the element Cu are concentrated in a region corresponding to the Cu plating layer 41, and the region is thus shown to be bright. FIGS. 9C, 9D, and 9E are characteristic X-ray images showing the presence of respective elements oxygen (O), phosphorus (P), and potassium (K), which were observed in the EDX analysis of the Q portion. In the images of FIGS. 9C, 9D, and 9E, bright spots showing the presence of the respective elements oxygen (O), phosphorus (P), and potassium (K) can be seen at the boundary portion between the Cu plating layer 41 and the element body 2. This shows that the intermediate layer 6 containing oxygen (O), phosphorus (P), and potassium (K) as in-film elements is formed at the boundary portion between the Cu plating layer 41 and the element body 2.

Further, the bright spot groups showing the presence of the elements oxygen (O), phosphorus (P), and potassium (K) are discontinuous along the surface of the element body 2 and the shapes formed by the outer edges of the bright spot groups are not rectangular. This shows that the intermediate layer 6 is formed discontinuously along the surface of the element body 2 and the thickness thereof is not uniform along the surface of the element body 2.

Note that a black image including no bright spot is obtained as the characteristic X-ray image of the element not contained in the intermediate layer 6. For example, in the EDX analysis of the intermediate layer 6 of Example 1, the characteristic X-ray image of potassium (K) corresponding to FIG. 9E is a black image including no bright spot.

### Evaluation of Fixing Force of Outer Electrode

The fixing force of the outer electrodes 4 with respect to the element body 2 was evaluated in accordance with a fixing property (shear strength) test described in AEC-Q200 Rev E, which is a standard regarding the reliability of in-vehicle passive components defined by the Automotive Electronics Council (AEC). Specifically, the outer electrodes 4 of the respective inductors 1 of Examples 1 to 6 and Comparative Example were soldered to a test substrate (FR-4) by reflow, and then a pressure of 17.7 N was applied perpendicularly to the side surfaces of the inductors 1 for 60 seconds to evaluate the presence or absence of peeling of the inductors 1 from the test substrate.

### 3.2.2 Evaluation Results

The evaluation results are shown in Table 2.

TABLE 2

| | | | | | Fixing test |
|---|---|---|---|---|---|
| | | | | | (Number of |
| | Intermediate layer | | | | unqualified |
| | Presence or | In-film | Average film | | samples/number |
| | absence | element | thickness | | of samples) |
| Example 1 | Present | P, O | 1 | μm | 0/30 |
| Example 2 | Present | S, O | 1 | μm | 0/30 |
| Example 3 | Present | P, O, K | 1 | μm | 0/30 |
| Example 4 | Present | S, O, K | 1 | μm | 0/30 |
| Example 5 | Present | P, O, K | 0.5 | μm | 0/30 |
| Example 6 | Present | P, O, K | 20 | μm | 0/30 |

| | | | | |
|---|---|---|---|---|
| Comparative | Absent | — | — | 5/30 |
| Example | | | | |

As shown in Table 2, in Comparative Example without the intermediate layer 6, peeling of the outer electrode 4 was observed in 5 pieces of the 30 samples in the fixing test. On the other hand, in each of Examples 1 to 6 including the intermediate layer 6, peeling of the outer electrode 4 was not observed in all of the 30 pieces of inductors 1. Thus, it was confirmed that the intermediate layer 6 containing phosphorus and oxygen or containing sulfur and oxygen as the in-film elements had an effect of improving the fixing strength of the Cu plating layer 41 of the outer electrode 4 with respect to the element body 2.

In addition, from the comparison between Examples 3 to 6 and Examples 1 and 2, it was confirmed that, even when the intermediate layer 6 further contained K as the in-film element, the effect of improving the fixing strength of the Cu plating layer 41 with respect to the element body 2 was obtained, as in the case that K was not contained.

Furthermore, from the comparison of Examples 3, 5, and 6, it was confirmed that as the immersion time of the element body 2 in the treatment liquid was longer in the intermediate layer forming step (S6), the thicker intermediate layer 6 was formed, and that the intermediate layer 6 was able to exhibit the effect of improving the fixing strength of the Cu plating layer 41 when the average thickness was at least in the range of 20 μm or less.

### 4. OTHER EMBODIMENTS

In the above-described embodiment, the core 30 includes two types of magnetic particles having mutually-different average particle sizes as the metal magnetic particles 30a, but may be composed of one type of magnetic particles.

Further, the Cu plating layer 41 is formed by electrolytic plating in the above-described embodiment, but may be formed by electroless copper plating.

Note that all of the above-described embodiments and examples are merely examples of one aspect of the present disclosure, and any modifications and applications can be made without departing from the spirit of the present disclosure.

In addition, unless otherwise specified, the directions such as horizontal and vertical directions, and various numerical values, shapes, and materials in the above-described embodiments include ranges (so-called equivalent ranges) in which the same advantageous effects as those of the directions, numerical values, shapes, and materials are exhibited.

### 5. CONFIGURATIONS SUPPORTED BY ABOVE-DESCRIBED EMBODIMENTS AND EXAMPLES

The embodiments and examples described above support the following configurations.

(Configuration 1) An inductor including an element body that contains metal magnetic particles and a resin and encloses a coil conductor; and an outer electrode that is disposed on a surface of the element body and connected to the coil conductor, and includes a copper plating layer, in which the metal magnetic particles include particles containing iron (Fe), and an intermediate layer containing phosphorus (P) and oxygen (O) or containing sulfur(S) and oxygen (O) is provided between the surface of the element body and the copper plating layer of the outer electrode.

According to the inductor of Configuration 1, it is possible to effectively prevent reduction in the fixing strength between the copper plating layer and the element body caused by a substitution reaction between copper in a plating solution and iron (Fe) of the metal magnetic particles on the surface of the element body, which may occur when the element body is immersed in the plating solution in the step for forming the copper plating layer, and to improve the connection strength between the outer electrode, which includes the copper plating layer, and the element body.

(Configuration 2) The inductor according to Configuration 1, in which the intermediate layer is disposed at least between the metal magnetic particles and the copper plating layer.

According to the inductor of Configuration 2, it is possible to more effectively prevent reduction in the fixing strength between the copper plating layer and the element body caused by the Fe—Cu substitution reaction in the step for forming the copper plating layer, and to improve the connection strength between the outer electrode and the element body.

(Configuration 3) The inductor according to Configuration 1 or 2, in which an element body protection layer that is an insulating film is disposed in a region other than a region, in which the outer electrode is formed, in the surface of the element body.

According to the inductor of Configuration 3, it is possible to prevent an unnecessary copper plating layer from being formed in a region in the surface of the element body where the outer electrode is not formed.

(Configuration 4) The inductor according to Configuration 3, in which the intermediate layer is not disposed between the element body and the element body protection layer.

According to the inductor of Configuration 4, it is possible to prevent an adverse effect on the adhesion strength between the element body and the element body protection layer, which may occur when the intermediate layer is present between the surface of the element body and the element body protection layer.

(Configuration 5) The inductor according to any one of Configurations 1 to 4, in which the outer electrode includes a nickel (Ni) plating layer and a tin (Sn) plating layer over the copper plating layer, the copper plating layer being formed on the surface of the element body with the intermediate layer interposed therebetween.

According to the inductor of Configuration 5, it is possible to configure the outer electrode with excellent corrosion resistance and solder wettability while improving the fixing strength between the outer electrode and the element body.

(Configuration 6) The inductor according to any one of Configurations 1 to 5, in which the intermediate layer further contains potassium (K).

According to the inductor of Configuration 6, the intermediate layer can be formed using a chemical agent containing the same components as those of a copper plating solution that contains potassium and can be generally used in the step for forming the copper plating layer. Therefore, according to the inductor of Configuration 6, a cleaning step between the intermediate layer forming step (S6) and the subsequent copper plating layer forming step can be omitted, being able to easily form the outer electrode (without introducing new chemical agent).

(Configuration 7) The inductor according to any one of Configurations 1 to 6, in which the intermediate layer has a thickness that is not uniform along the surface of the element body.

According to the inductor of Configuration 7, the intermediate layer does not need to be formed to have a uniform thickness along the surface of the element body. Therefore, according to the inductor of Configuration 7, the intermediate layer can be easily formed.

(Configuration 8) The inductor according to any one of Configurations 1 to 7, in which the intermediate layer is discontinuous along the surface of the element body.

According to the inductor of Configuration 8, the intermediate layer does not need to be continuously formed along the surface of the element body. Therefore, according to the inductor of Configuration 8, the intermediate layer can be easily formed.

(Configuration 9) The inductor according to any one of Configurations 1 to 8, in which the surface of the element body has a surface roughness of from 1.0 μm to 10 μm inclusive, the surface roughness being represented by an arithmetic average roughness Ra.

According to the inductor of Configuration 9, the anchoring effect generated by the uneven surface of the element body further increases the fixing force between the intermediate layer and the surface of the element body or the fixing force of the intermediate layer and the copper plating layer with respect to the surface of the element body, and thus the connection strength between the outer electrode and the surface of the element body can be further improved.

(Configuration 10) The inductor according to any one of Configurations 1 to 9, in which the intermediate layer has an average thickness of 20 μm or less.

According to the inductor of Configuration 10, the connection strength between the outer electrode and the surface of the element body can be improved while avoiding unnecessary limitation of the volume of the element body due to the presence of the intermediate layer (and thus avoiding unnecessary limitation of the electrical characteristics of the inductor) within the allowable range of the external dimensions required for the overall inductor.

(Configuration 11) A method for manufacturing an inductor, the method including a step for forming a coil having a pair of extended portions; a step for embedding the coil in an element body, the element body including metal magnetic particles containing iron (Fe) and a resin, such that the extended portions of the coil are exposed from a surface of the element body; and a step for at least partially forming an intermediate layer, the intermediate layer containing phosphorus (P) and oxygen (O) or containing sulfur(S) and oxygen (O), in an outer electrode forming region, which includes the extended portions exposed from the element body, on the surface of the element body. The method further includes a step for forming an outer electrode including a copper (Cu) plating layer in the outer electrode forming region at least partially formed with the intermediate layer.

According to the method for manufacturing an inductor of Configuration 11, an inductor can be manufactured in which it is possible to effectively prevent reduction in the fixing strength between the copper plating layer and the element body caused by a substitution reaction between copper in a plating solution and iron (Fe) of the metal magnetic particles on the surface of the element body, which may occur when the element body is immersed in the plating solution in the step for forming the copper plating layer, and to improve the connection strength between the outer electrode, which includes the copper plating layer, and the element body.

What is claimed is:

1. An inductor comprising:
an element body that includes metal magnetic particles and a resin and encloses a coil conductor, the metal magnetic particles including particles including iron (Fe);
an outer electrode that is on a surface of the element body and connected to the coil conductor, and includes a copper plating layer; and
an intermediate layer including phosphorus (P) and oxygen (O), or including sulfur(S) and oxygen (O), between the surface of the element body and the copper plating layer of the outer electrode.

2. The inductor according to claim 1, wherein
the intermediate layer is at least between the metal magnetic particles and the copper plating layer.

3. The inductor according to claim 1, further comprising:
an element body protection layer that is an insulating film is in a region other than a region, in which the outer electrode is present, in the surface of the element body.

4. The inductor according to claim 3, wherein
the intermediate layer is not between the element body and the element body protection layer.

5. The inductor according to claim 1, wherein
the outer electrode includes a nickel (Ni) plating layer and a tin (Sn) plating layer over the copper plating layer, the copper plating layer being on the surface of the element body with the intermediate layer interposed therebetween.

6. The inductor according to claim 1, wherein
the intermediate layer further includes potassium (K).

7. The inductor according to claim 1, wherein
the intermediate layer has a thickness that is not uniform along the surface of the element body.

8. The inductor according to claim 1, wherein
the intermediate layer is discontinuous along the surface of the element body.

9. The inductor according to claim 1, wherein
the surface of the element body has a surface roughness of from 1.0 μm to 10 μm inclusive, the surface roughness being represented by an arithmetic average roughness Ra.

10. The inductor according to claim 1, wherein
the intermediate layer has an average thickness of 20 μm or less.

11. The inductor according to claim 2, wherein
the intermediate layer has an average thickness of 20 μm or less.

12. The inductor according to claim 3, wherein
the intermediate layer has an average thickness of 20 μm or less.

13. The inductor according to claim 4, wherein
the intermediate layer has an average thickness of 20 μm or less.

14. The inductor according to claim 5, wherein
the intermediate layer has an average thickness of 20 μm or less.

15. The inductor according to claim 6, wherein
the intermediate layer has an average thickness of 20 μm or less.

16. The inductor according to claim 7, wherein
the intermediate layer has an average thickness of 20 μm or less.

17. The inductor according to claim 8, wherein
the intermediate layer has an average thickness of 20 μm or less.

18. The inductor according to claim 9, wherein
the intermediate layer has an average thickness of 20 μm or less.

19. A method for manufacturing an inductor, the method comprising:
for forming a coil having a pair of extended portions;
embedding the coil in an element body, the element body including metal magnetic particles including iron (Fe) and a resin, such that the extended portions of the coil are exposed from a surface of the element body;
at least partially forming an intermediate layer, the intermediate layer including phosphorus (P) and oxygen (O), or including sulfur(S) and oxygen (O), in an outer electrode forming region, which includes the extended portions exposed from the element body, on the surface of the element body; and
forming an outer electrode including a copper (Cu) plating layer in the outer electrode forming region at least partially formed with the intermediate layer.
